(19) United States
(12) Patent Application Publication
(10) Pub. No.: US 2004/0264749 A1
(43) Pub. Date: Dec. 30, 2004

(54) Boundary finding in dermatological examination

(76) Inventors: Victor Nickolaevick Skladnev, New South Wales (AU); Scott Menzies, New South Wales (AU); Adrew Batrac, New South Wales (AU); David Varvel, New South Wales (AU); Leanne-Margaret Bischof, New South Wales (AU); Hugues Gustave Francois Talbot, New South Wales (AU)

Correspondence Address: GOTTLIEB RACKMAN & REISMAN PC, 270 MADISON AVENUE, 8TH FLOOR, NEW YORK, NY, 100160601

(21) Appl. No.: 10/478,077

(22) PCT Filed: May 17, 2002
(86) PCT No.: PCT/AU02/00603

(30) Foreign Application Priority Data
May 18, 2001 (AU) PR 5098

(51) Int. Cl. G06K 9/00

(52) U.S. Cl. 382/128

(57) ABSTRACT

An image (502) of an area of skin that includes a lesion (304) is captured. An annular variance test is performed on pixels around the lesion (304) (step 514). Based on the results of the annular variance test, either a seeded region growing method (step 516) or a colour clustering method (step 520) is applied to the image (502) to calculate a boundary of the lesion (304). The colour cluster method may produce multiple selectable boundaries. Provision is also made for a lesion boundary to be manually traced (step 522).

### FIELD OF THE INVENTION

The present invention relates to the examination of dermatological anomalies and, in particular, to the accurate determination of the border of lesions and like structures as a precursor to automated or other investigation of the nature of the lesion.

### BACKGROUND

Malignant melanoma is a form of cancer due to the uncontrolled growth of melanocytic cells under the surface of the skin. These pigmented cells are responsible for the brown colour in skin and freckles. Malignant melanoma is one of the most aggressive forms of cancer. The interval between a melanoma site becoming malignant or active and the probable death of the patient in the absence of treatment may be short, of the order of only six months. Deaths occur due to the spread of the malignant melanoma cells beyond the original site through the blood stream and into other parts of the body. Early diagnosis and treatment is essential for favourable prognosis.

However, the majority of medical practitioners are not experts in the area of dermatology and each might see only a few melanoma lesions in any one year. As a consequence, the ordinary medical practitioner has difficulty in assessing a lesion properly.

The examination of skin lesions and the identification of skin cancers such as melanoma have traditionally been performed with the naked eye. More recently, dermatologists have used hand-held optical magnification devices generally known as a dermatoscope (or Episcope). Such devices typically incorporate a source of light to illuminate the area under examination and a flat glass window which is pressed against the skin in order to flatten the skin and maximise the area of focus. The physician looks through the instrument to observe a magnified and illuminated image of the lesion. The dermatoscope is typically used with an index matching medium, such as mineral oil, which is placed between the window and the patient's skin. The purpose of the “index matching oil” is to eliminate reflected light due to a mis-match in refractive index between skin) and air. An expert dermatologist can identify over 70 different morphological characteristics of a pigmented lesion. Whilst the dermatoscope provides for a more accurate image to be represented to the physician, the assessment of the lesion still relies upon the manual examination and the knowledge and experience of the physician.

More recently automated analysis arrangements have been proposed which make use of imaging techniques to provide an assessment of the lesion and a likelihood as to whether or not the lesion may be cancerous. Such arrangements make use of various measures and assessments of the nature of the lesion to provide the assessment as to whether or not it is malignant. Such measures and assessments can include shape analysis, colour analysis and texture analysis, amongst others.

A significant problem of such arrangements is the computer processing complexity involved in performing imaging processes and the need or desire for those processes to be able to be performed as quickly as possible. If processing can be shortened, arrangements may be developed whereby an assessment of a lesion can be readily provided to the patient, possibly substantially coincident with optical examination by the physician and/or automated arrangement (ie. a “real-time” diagnosis).

One mechanism by which the speed of image processing can be enhanced is by limiting the amount of image data to be processed. Typically, when an image is captured of a lesion, the image taken includes both suspect and non-suspect skin. Where a specific area of interest can be identified from the captured image, computerised image processing can be limited to that specific area thereby providing for optimised speed of processing.

More importantly, identification of certain features of a lesion and the consequential categorisation can be erroneous if skin is included within the processing that should be applied to the lesion. Accordingly, it is important to accurately isolate within the captured image that portion that may be considered as lesion.

The traditional approach to identifying the specific region of interest is for the physician, once having obtained an image of the lesion surrounded by otherwise non-suspect skin, to electronically trace out the border or boundary of the lesion using a computerised pointer apparatus, such as a mouse device or pen pointer. Having created a specific boundary for the lesion, the physician may then instigate image processing on the parts of the image within the boundary. Such an arrangement is however time consuming as such requires accurate tracing of the outline of the lesion by the physician. The accuracy of tracing is important since the incorporation of good skin, by making the boundary too large, may prolong image processing and also provide a false diagnosis of the nature of the image region. Also, making the boundary too small may exclude cancerous tissue from further processing which may give rise to a false negative indication.

### SUMMARY OF THE INVENTION

It is an object of the present invention to substantially overcome, or at least ameliorate, one or more deficiencies of prior art arrangements.

The invention relates to the determination of a boundary of a lesion. An image is obtained of the lesion and a surrounding area of skin. The lesion boundary is calculated using either or both of a seeded region-growing method and a colour cluster method. A preliminary test on the image determines which of the methods is used initially. The colour cluster method generates a plurality of selectable boundaries.

According to a first aspect of the present disclosure, there is provided a method of determining a boundary of a lesion on the skin of a living being, said method comprising the steps of:

obtaining an image of the lesion and a surrounding skin area;

performing a test upon pixels in said image representing a predetermined portion of said surrounding skin area;

and, in response to said test, performing at least one of;

(a) a seeding region growing method to determine a boundary of said lesion; and

(b) a colour cluster method to determine a plurality of selectable boundaries of said image.

According to a second aspect of the present disclosure, there is provided a method for forming a transformation matrix for application to images for dermatological examination, said method comprising the steps of:

obtaining sample data representing a plurality of skin images each including at least one lesion and surrounding skin;

arranging said data in a single three-dimensional colour space as a single set of pixels;

determining, from said set of pixels, principal component axes thereof; and

using the principal component axes to determine a corresponding transformation matrix thereof.

According to a third aspect of the present disclosure, there is provided a method of determining seed pixels as a precursor to seeded region growing to identify the boundary of a skin lesion in dermatological examination, said method comprising the steps of:

(a) obtaining a source image of the lesion and a surrounding area of skin;

(b) performing a dimension reduction transformation upon colour components of said image to form first and second transformed images;

(c) computing a bivariate histogram using said transformed images;

(d) forming from said histogram a (first) mask to identify, in the transformation space, relative locations of lesion pixels, skin pixels and unknown pixels;

(e) applying the first mask to at least one of the transformed images to form an initial segmentation; and

(f) applying at least one further mask to said initial segmentation to remove unwanted portions of said image to reveal seed pixels for each of lesion and skin.

According to a fourth aspect of the present disclosure, there is provided a method of determining a boundary of a lesion on the skin of a living being, said method comprising the steps of:

(i) determining at least lesion and skin seed pixels according to the method of the third aspect;

(ii) removing from said source image unwanted regions thereof to form a working image;

(iii) growing at least said lesion seed pixels and said skin seed pixels by applying a region growing process to said seed pixels in said working image; and

(iv) masking out said skin pixels from said grown image to form a mask defining the boundary of said grown lesion pixels.

According to a fifth aspect of the present disclosure, there is provided a method of determining a boundary of a lesion on the skin of a living being, said method comprising the steps of:

(a) obtaining a source image of the lesion including a surrounding area of skill;

(b) forming a bivariate histogram from dimension reduction transformations of said source image;

(c) segmenting said source image using a segmentation of said histogram and classifying the segments;

(d) ordering the segments on the basis of increasing lightness;

(e) applying the classified segments in order to said image to form, for each application, a corresponding boundary related to said lesion; and

(f) selecting from said boundaries a representative boundary of said lesion

Other aspects are also disclosed.

### BRIEF DESCRIPTION OF THE DRAWINGS

At least one embodiment of the present invention will now be described with reference to the drawings, in which:

FIG. 1 is a schematic block diagram representation of a computerised dermatological examination system;

FIG. 2 is a schematic representation of the camera assembly of FIG. 1 when in use to capture an image of a lesion;

FIG. 3 is a schematic block diagram representation of a data flow of the system of FIG. 1;

FIG. 4 is a flow diagram of the imaging processes of FIG. 3;

FIG. 5 is a flow diagram representing the generalised approach to boundary finding in accordance with the present disclosure;

FIGS. 6A and 6B is a flow diagram of the seeded region growing process of FIG. 5;

FIG. 7 is a photographic representation of a lesion;

FIG. 8 is a processed version of the image of FIG. 7 with hair, bubbles, and calibration components removed;

FIGS. 9 and 10 are representations of principal component transformations of the image of FIG. S;

FIG. 11A is a representation of a bivariate histogram formed using the principal component images of FIGS. 9 and 10;

FIG. 11B shows a zoomed representation of the bivariate histogram of FIG. 11A;

FIG. 12 is a representation of the bivariate histogram mask used to interpret the histogram of FIG. 11A;

FIG. 13 is a representation of the second principal component image with hair artifacts removed;

FIG. 14 is a representation of the image processed using the mask of FIG. 12 applied to the principal component images with artifacts removed;

FIG. 15 is a process version of FIG. 14 to represent seed pixels to be used for seeded region growing,

FIG. 16 shows the image after seeded region growing is completed;

FIG. 17 is a final process version of the image of FIG. 7 representing a mask of the region of interest as a result of seeded image growing;

FIG. 18 is a schematic block diagram of a computer system upon which the processing described can be practiced;

FIG. 19 is a flow chart representing an alternative to part of the process of FIGS. 6A and 6B;

FIG. 20A is a flow chart depicting colour cluster multiple boundary detection;

FIGS. 20B to 20E are flow charts of the various steps depicted in FIG. 20A;

FIGS. 21 and 22 show the formation of seed regions in the bivariate histogram;

FIGS. 23 to 26 show the segmentation of regions in the bivariate histogram;

FIG. 27 is a mask applied to the segmentation of FIG. 26;

FIG. 28 is a segmentation of the lesion image;

FIG. 29 shows the lesion image divided according to the colour clusters;

FIG. 30 shows boundaries related to various colour clusters;

FIGS. 31A and 31B show the use of the watershed transform; and

FIG. 32 depicts the manner in which the colour cluster multiple borders may be displayed.

### DETAILED DESCRIPTION

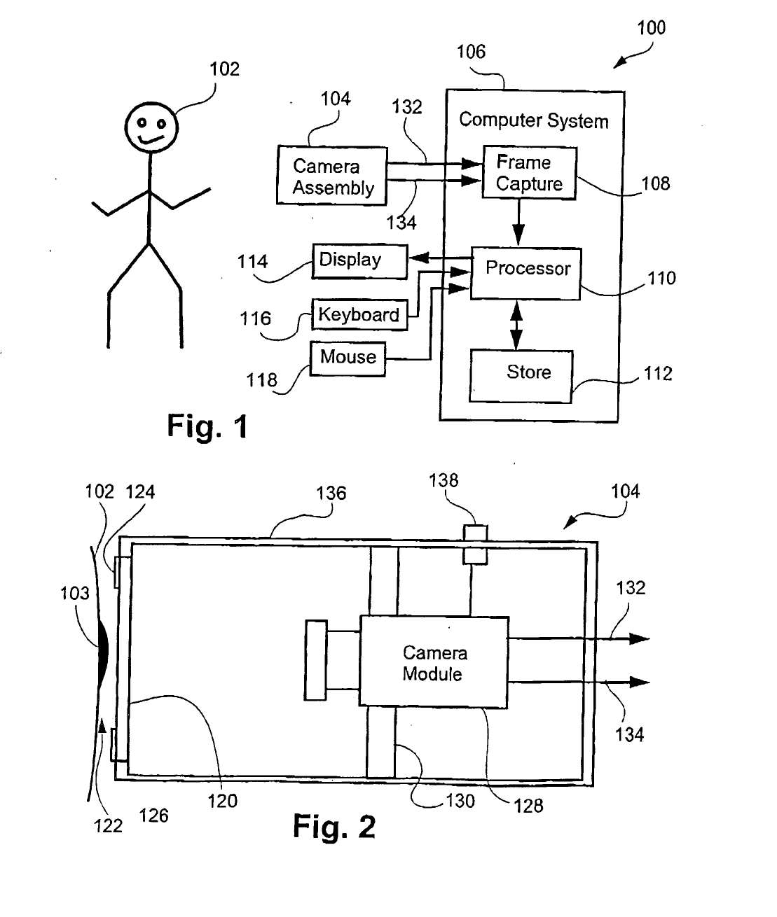

FIG. 1 shows an automated dermatological examination system 100 in which a camera assembly 104 is directed at a portion of a patient 102 in order to capture an image of the skin of the patient 102 and for which dermatological examination is desired. The camera assembly 104 couples to a computer system 106 which incorporates a frame capture board 108 configured to capture a digital representation of the image formed by the camera assembly 104. The frame capture board 108 couples to a processor 110 which can operate to store the captured image in a memory store 112 and also to perform various image processing activities on the stored image and variations thereof that may be formed from such processing and/or stored in the memory store 112. Also coupled to the computer system via the processor 110 is a display 114 by which images captured and/or generated by the system 106 may be represented to the user or physician, as well as keyboard 116 and mouse pointer device 118 by which user commands may be input.

As seen in FIG. 2, the camera assembly 104 includes a chassis 136 incorporating a viewing window 120 which is placed over the region of interest of the patient 102 which, in this case, is seen to incorporate a lesion 103. The window 120 incorporates on an exterior surface thereof and arranged in the periphery of the window 120 a number of colour calibration portions 124 and 126 which can be used as standardised colours to provide for colour calibration of the system 100. Such ensures consistency between captured images and classification data that may be used in diagnostic examination by the system 100. As with the dermatoscope as described above, an index matching medium, such as oil, is preferably used in a region 122 between the window 120 and the patient 102 to provide the functions described above.

The camera assembly 104 further includes a camera module 128 mounted within the chassis from supports 130 in such a manner that the camera module 128 is fixed in its focal length from the exterior surface of the glass window 120, upon which the patient's skin is pressed. In this fashion, the optical parameters and settings of the camera module 128 may be preset and need not be altered for the capture of individual images. The camera module 128 includes an image data output 132 together with a data capture control signal 134, for example actuated by a user operable switch 138. The control signal 134 may be used to actuate the frame capture board 108 to capture the particular frame image currently being output on the image connection 132. As a consequence, the physician, using the system 100 has the capacity to move the camera assembly 104 about the patient and into an appropriate position over the lesion 103 and when satisfied with the position (as represented by a real-time image displayed on the display 114), may capture the particular image by depression of the switch 138 which actuates the control signal 134 to cause the frame capture board 108 to capture the image.

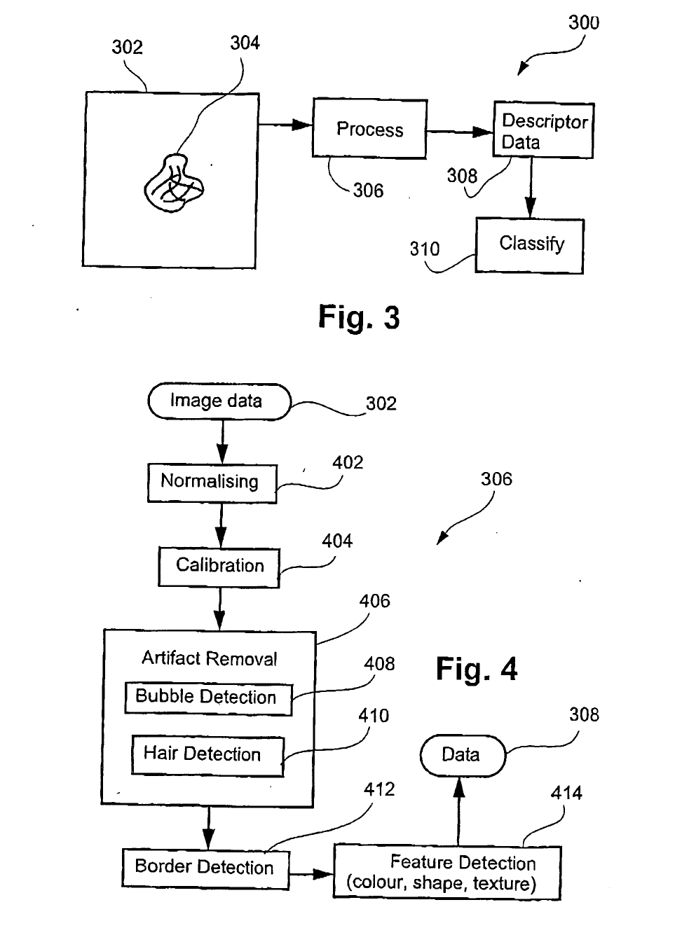

FIG. 3 depicts a generalised method for diagnosis using imaging that is performed by the system 100. An image 302, incorporating a representation 304 of the lesion 103, forms an input to the diagnostic method 300. The image 302 is manipulated by one or more processes 306 to derive descriptor data 308 regarding the nature of the lesion 103. Using the descriptor data 309, a classification 310 may be then performed to provide to the physician with information aiding a diagnosis of the lesion 103.

FIG. 4 shows a further flow chart representing the various processes formed within the process module 306. Initially, image data 302 is provided to a normalising and system colour tinge correction process 402 which acts to compensate for light variations across the surface of the image. The normalised image is then provided to a calibration process 404 which operates to identify the calibration regions 124 and 126, and to note the colours thereof, so that automated calibration of those detected colours may be performed in relation to reference standards stored within the computer system 106. With such colours within the image 302 may be accurately identified in relation to those calibration standards.

The calibrated image is then subjected to artifact removal 406 which typically includes bubble detection 408 and hair detection 410. Bubble detection acts to detect the presence of bubbles in the index matching oil inserted into the space 122 and which can act to distort the image detected. Hair detection 410 operates to identify hair within the image and across the surface of the skin and so as to remove the hair from the image process. Bubble detection and hair detection processes are known in art and any one of a number of known arrangements may be utilised for the purposes of the present disclosure. Similarly, normalisation and calibration processors are also known.

After artifacts are removed in step 406, border detection 412 is performed to identify the outline/periphery of the lesion 103. Once the border is detected, feature detection 414 is performed upon pixels within the detected border to identify features of colour, shape and texture, amongst others, those features representing the descriptor data 308 that is stored and is later used for classification purposes.

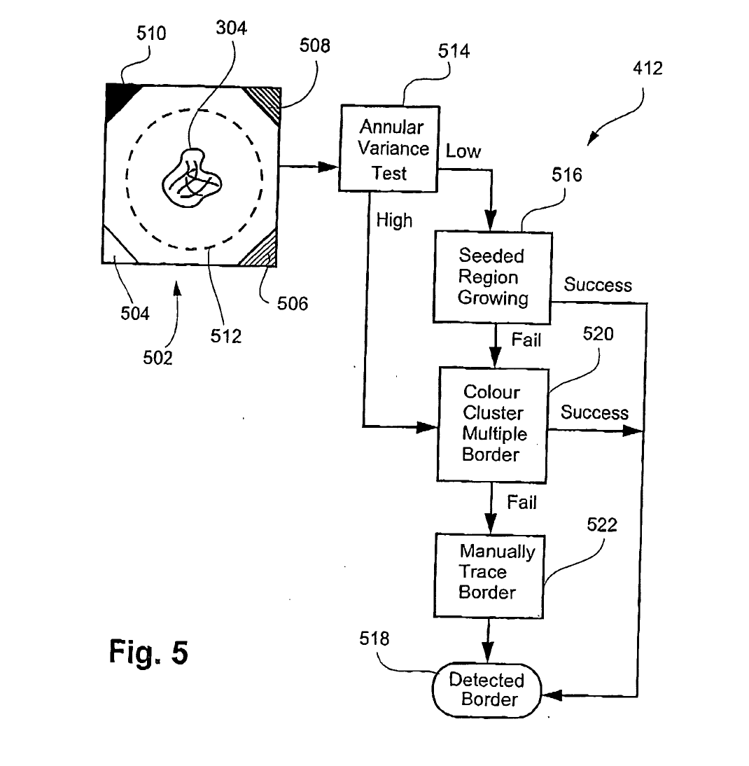

The general approach to border detection 412, the subject of the present disclosure, is depicted in FIG. 5. In FIG. 5, the representation of the captured image 502 is shown which incorporates a number of colour calibration regions 504, 506, 508 and 510 arranged in the periphery or corners of the image and which may be used for the colour calibration tests mentioned previously. In the preferred implementation, the regions 504-510 represent a grey scale from white to black which, in red, green and blue (RGB) colour space represent defined levels of each colour component. Alternatively, known colour primaries may be used.

Surrounding the lesion representation 304 in the image 502 is a circle 512 which does not form part of the image 502 but rather represents a locus of points about which an annular variance test 514 is performed upon the image data of the image. In particular, pixels coincident with the circle 512 are tested with respect to colour by the annular variance test 514 such that where those pixels display a statistical variance in colour below a predetermined threshold, a seeded region growing border detection process 516 is then performed. Where the annular variance exceeds the predetermined threshold, thereby indicating a high variance of pixel colour about the circle 512, the seeded region growing process 516 is skipped and a colour cluster multiple border process 520 is performed. Further, where the seeded region growing process 516 is successful in providing a detected border 518, the border detection process 412 ceases. Where the seeded region growing 516 fails to detect an appropriate border to the satisfaction of the physician, the colour cluster multiple border process 520 is then performed. Similarly, if the process 520 fails to detect an appropriate border, the physician may then manually trace the border at step 522, in a fashion corresponding to prior art methods. The annular variance test 514 is optional and does not influence the results of seeded region growing or colour cluster multiple border detection. In some instances however, such can accelerate the derivation of the desired boundary.

The success or failure of each of the processes 516 and 520 is ultimately determined by the physician through representation of the original captured image 502 on the display 114 overlayed by a corresponding representation of the detected border from the respective process 516 or 520. Where the physician is satisfied with the result of the automated border detection, that border is then selected as the detected border 518 by the physician. As a consequence, whilst the border detection arrangement 412 provides automated detection of the border of the lesion 103, the ultimate determination as to whether or not that border is used resides in the physician who, as a last resort, may then choose to perform his own manual detection of the border using the traditional tracing approach.

The present disclosure is particularly concerned with the automated assistance of border detection, this being the annular variance test 514, the seeded region growing approach 516 and the colour cluster multiple border approach 520.

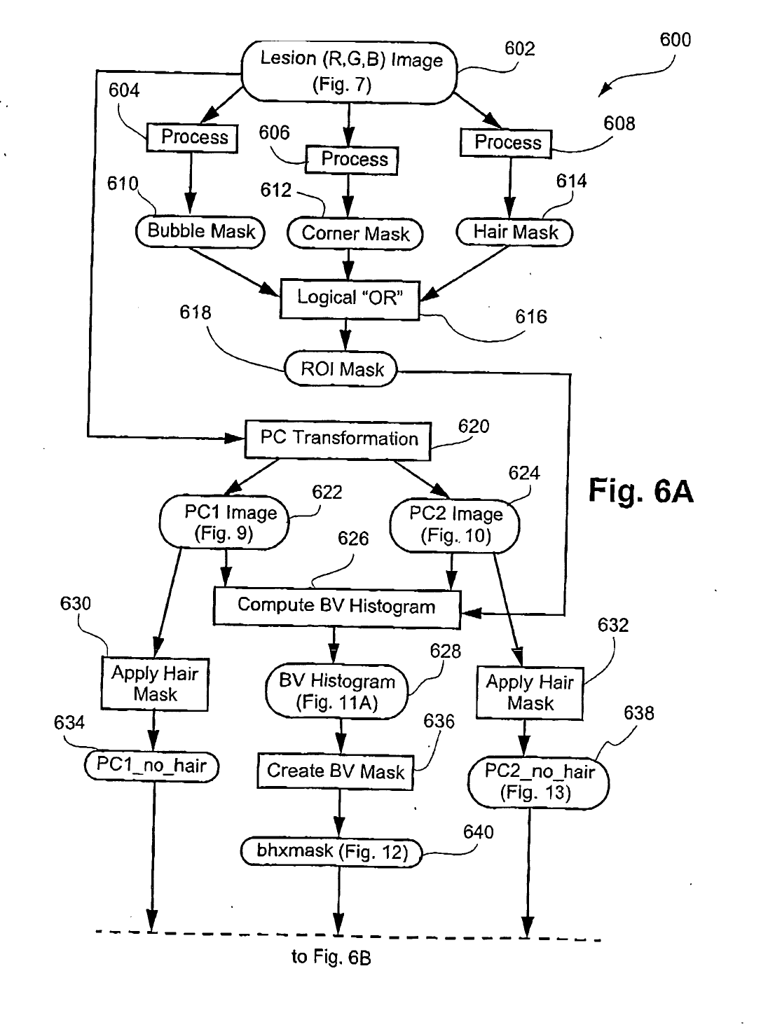

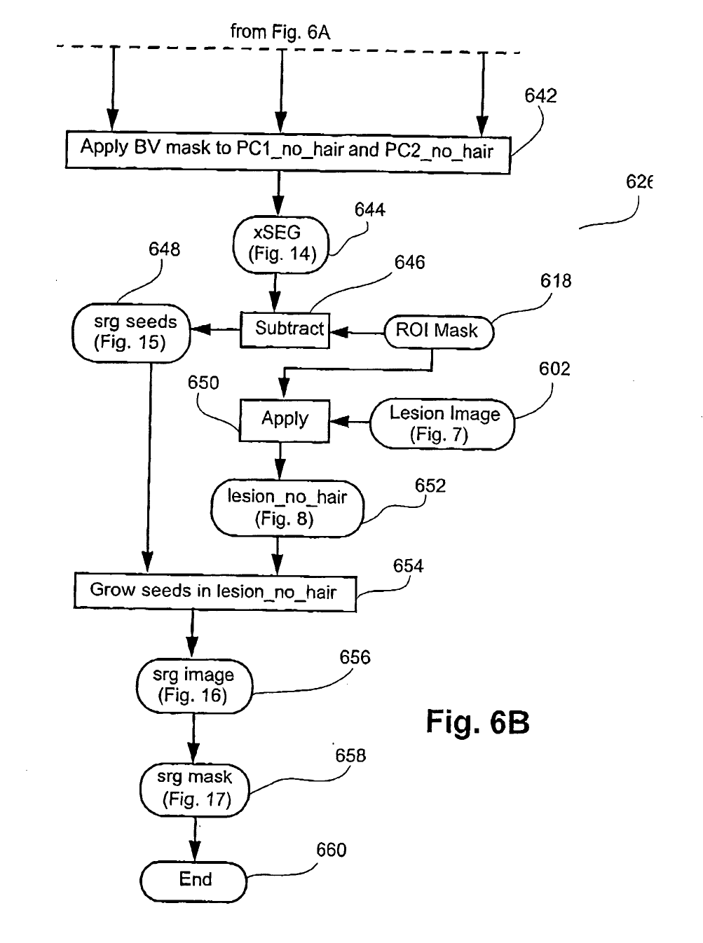

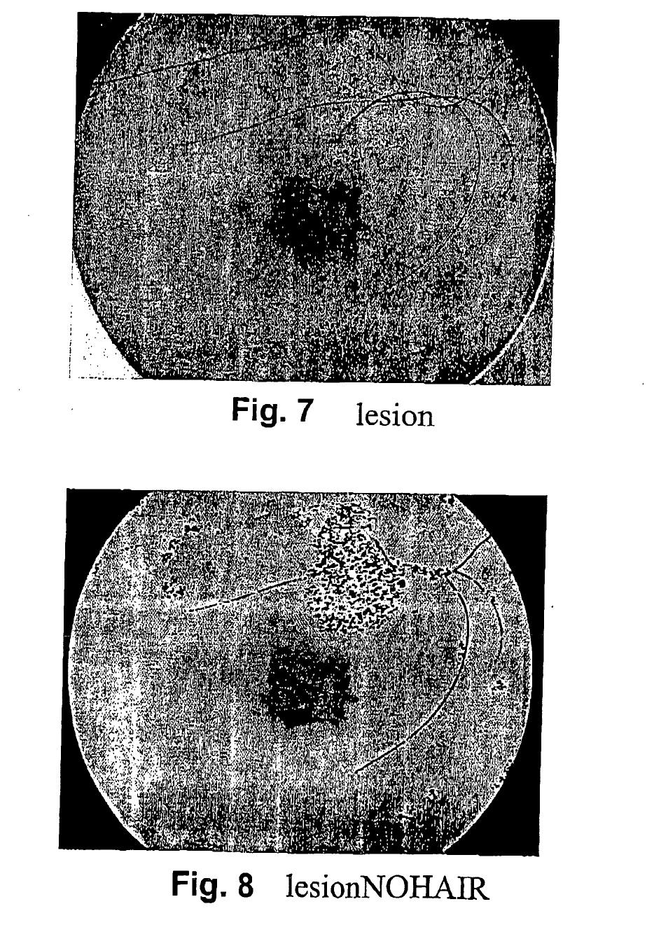

With reference to FIGS. 6A to 17, the seeded region growing process 516 can be described by way of flow chart 600 of FIGS. 6A and 6B and the various images contained in FIGS. 7 to 17.

The process 600 shown in FIGS. 6A and 6B acts to identify particular “seed” pixels within the image, and from which seeded region growing may be performed. The growing of the seeds establishes the specific border of the grown region which then represents the border of the lesion 103, this being the specific area of interest for diagnostic evaluation.

Referring to FIG. 6A, the method 600 commences with a raw RGB (red, green, blue) image 602 of the lesion and surrounding areas. An example of this is shown in FIG. 7 where the image as seen clearly illustrates a mass centrally located within the image, with various human hairs and bubbles distributed across the image together with colour calibration regions arranged in the corners of the image, as described above. Using the raw image 602, three processes 604, 606 and 608 are then performed, these being equivalent to the steps 402-410 of FIG. 4 described above.

The processes 604-608 respectively result in masks 610, 612 and 614 which may be used to remove bubbles, corner identifiers and hair from the image. A logical “OR” operation 616 can be then used to combine the masks 610-614 to provide a region of interest (ROD mask 618. The various steps just described are essentially precursor steps to later steps for seed identification and seeded region growing, those later steps which will now be described with reference to the balance of FIG. 6A, and also FIG. 6B.

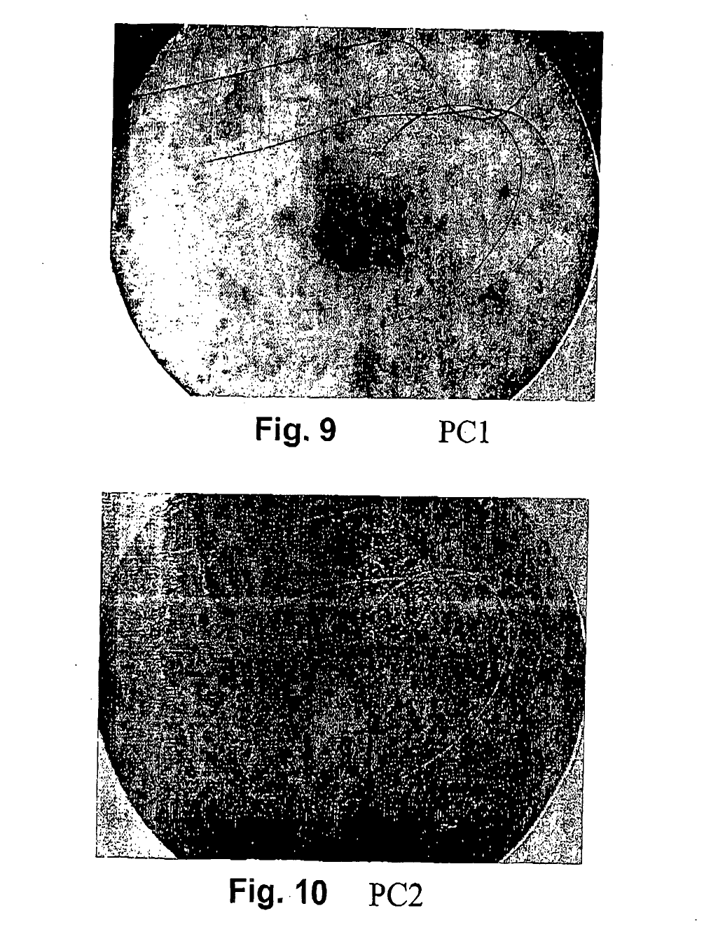

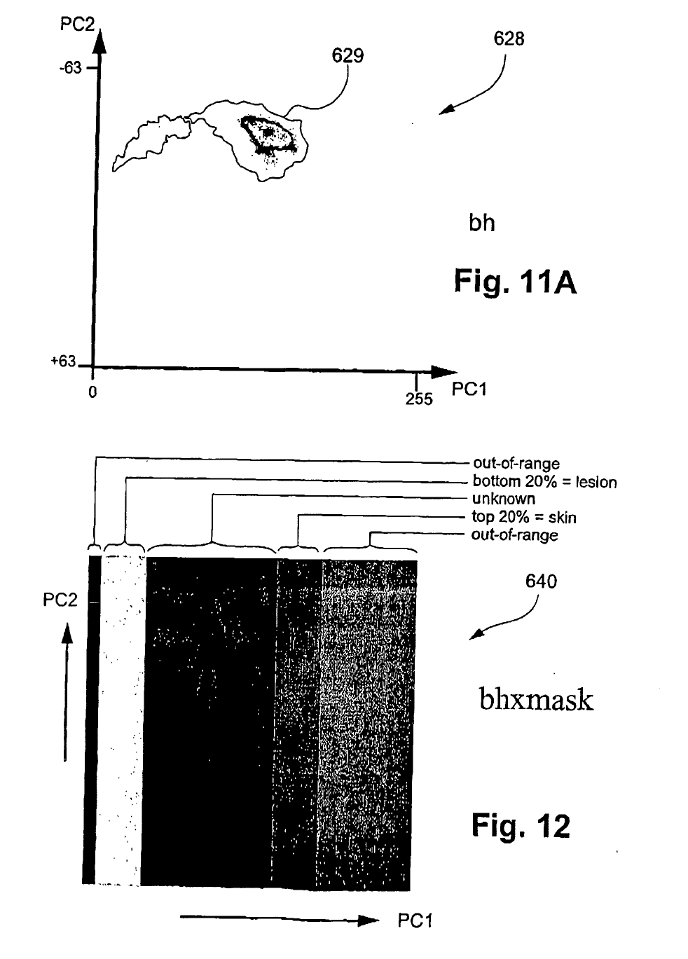

As also seen in FIG. 6A, the lesion image 602 is subjected to a principal component (PC) transformation 620. The transformation matrix used to perform the transformation 620 is formed from an amalgam of sample data obtained from numerous representative lesion images and the particular colours displayed therein. The sample data is arranged in a single three-dimensional colour space as a single set of pixels and the principal component axes thereof determined Using the principal component axes, a corresponding transformation matrix is then determined. This is to be contrasted with traditional principal component transformations where the transformation matrix is derived from the image to be transformed. By creating the transformation matrix used in step 620 from a set of sample data, the axes of the transformation (ie. PC1 and PC2) are fixed in colour space for all lesions to be processed. This achieves in the present arrangements a reduction in the image dimensionality from three to two. The PC transformation 620 results in a PC1 image 622 as seen in FIG. 9, and a PC2 image 624 as seen in FIG. 10. The PC transformation 620 effectively converts the lesion image 602 from its three-dimensions of red, green and blue (RGB) to two two-dimensional representations. FIG. 9 clearly displays a large range of intensities (eg. light to dark) whereas FIG. 10 displays substantially uniform intensity. This last point is specifically seen by comparing FIGS. 9 and 10. In FIG. 9, the corner grey scale components are clearly illustrated in their different intensities, whereas in FIG. 10, those corner grey scale components have substantially identical intensities.

Using the PC images 622 and 624, a bivariate histogram is then computed in step 626. Step 626 also makes use of the ROI mask 618 to exclude hair, bubbles and corner segments which were contained in the lesion image 602, from which the PC images 622 and 624 were formed.

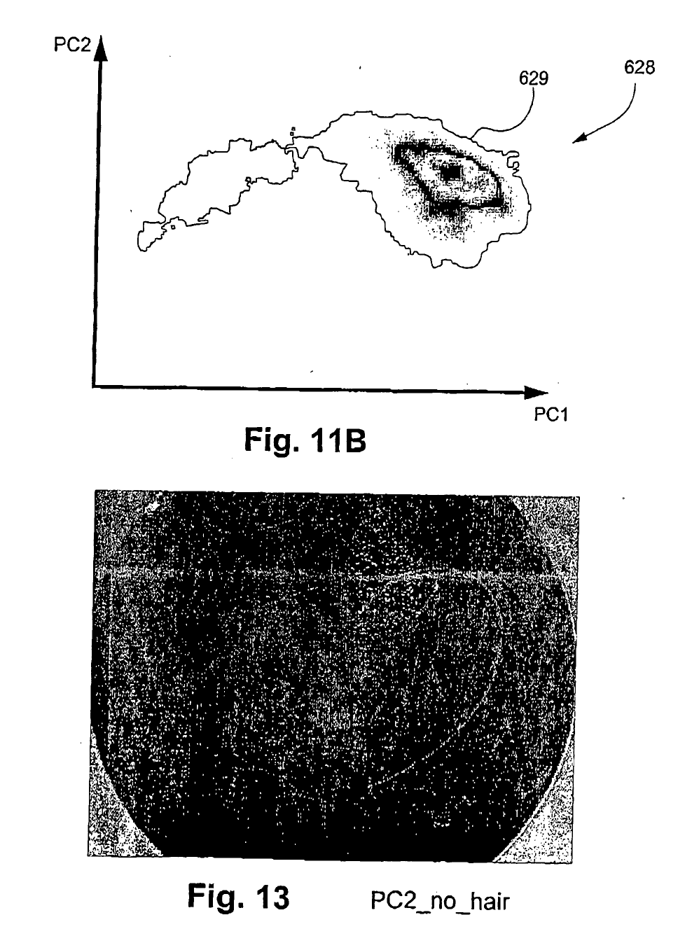

The computation of the bivariate histogram 626 results in the histogram 628 which is seen in FIG. 11A. As seen in FIG. 1A, the histogram has axes corresponding to PC1 and PC2. Importantly, in FIG. 1A, the representation of the bivariate histogram 628 has been supplemented by a manually formed outline 629 which has been provided to indicate the fill extent of the bivariate histogram, which may not readily be apparent in the representations as a result of degradation due to copying and/or other document reproduction processes. Importantly, the bivariate histogram 628 as seen includes a significant component towards its right-hand extremity which is representative of skin components within the lesion image of FIG. 7. The left-hand extremity of the bivariate histogram 628 includes a very small amount (indicated by extremely low intensity) of information indicative of lesion (eg. possible melanoma) content. In the representations being viewed by the reader of this patent specification, that component may appear as something of a smudge in FIG. 11A. For this purpose, a zoomed or expanded version of FIG. 11A is shown in FIG. 11B, also including an outline 629 where the “smudge” of FIG. 11A should be more readily apparent.

From the bivariate histogram 628 of FIG. 11A, in step 636, a bivariate mask 640 is created as shown in FIG. 12, The mask 640 is based upon the intensity information contained in the PC images 622 and 624. As a consequence, the mask 636 is formed upon the PC1 axis, and is invariant along the PC2 axis. The mask 640 indicates a number of regions of the bivariate histogram that relate to different areas of intensity which, from observational experience are indicative of the different types, skin and lesion. In particular, as seen in FIG. 12, the mask 640 includes two bounding out-of-range regions that represent that portion of the available dynamic range that is not occupied by pixels for the image in question. Those two out-of-range regions then define regions therebetween that may be considered to be lesion, skin or unknown, the later representing the area between lesion and skin. In this fashion, FIG. 12 may be aligned with FIG. 11A, as indicated on that sheet of drawings, to identify those portions of the bivariate histogram 628 that may be considered lesion, unknown or skin. This is performed by assigning the top and bottom 20% portions between the out-of-range regions as being “lesion” and “skin” respectively, the in-between remained being identified as “unknown”. The selection of 20% has, in the present implementation, been determined through experimentation for the identification of appropriate numbers of seed pixels for each of “lesion” and “skin”. Other ranges may be selected. It will be further appreciated by a comparison of FIGS. 11A and 12 that the large distinctive portion of the bivariate histogram of FIG. 1A resides on or about the border between the “unknown” region and the “skin” region.

Returning to FIG. 6A, the PC images 622 and 624 are separately processed by application of the hair mask 614 in each of steps 630 and 632. These processes result in the creation of her images 634 and 638 representing PC1_no_hair and PC2_no_hair, the latter being illustrated in FIG. 13.

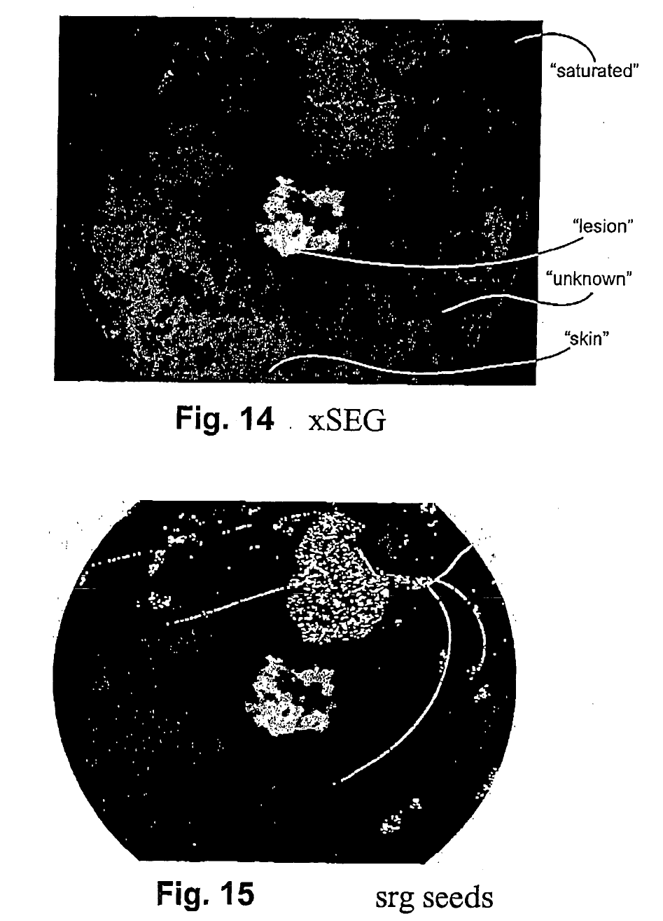

Turning now to FIG. 6B, being the extension of the method 600 of FIG. 6A, step 642 acts to apply the bivariate mask 636 to each of the PC1_no_hair 634 and PC2_no_hair 638 images to create an image 644 shown in FIG. 14 as xSEG 644. The image xSEG effectively comprises four components as marked, these being tissue identified as “lesion”, tissue identified as “skin”, tissue identified as “unknown” and an unwanted portion representing out-of-range/cut-off portions of the histogram. These are each labelled in FIG. 14.

In the following step 646, the xSEG image 644 of FIG. 14 is used to extract those portions that are known as skin and lesion, which are combined with the unwanted portions of the image representing the inverse, or NOT, of the ROI mask 618. This process results in the formation of an image 648 shown in FIG. 15, identified as “SRG seeds”. This image represents those portions of the processed image that comprise seed pixels for region growing techniques to be subsequently applied. The image 648 of FIG. 15 includes both “skin” seeds and “lesion” seeds.

In preparation for seeded region growing, the ROI mask 618 as seen in FIG. 61 is also applied at step 650 to the lesion image 602 of FIG. 7. The result of this application is a lesion_no_hair image 652 shown in FIG. 8. The image 652 then forms the basis upon which the seed pixels from the SRG seeds image 648 are grown in a following step 654.

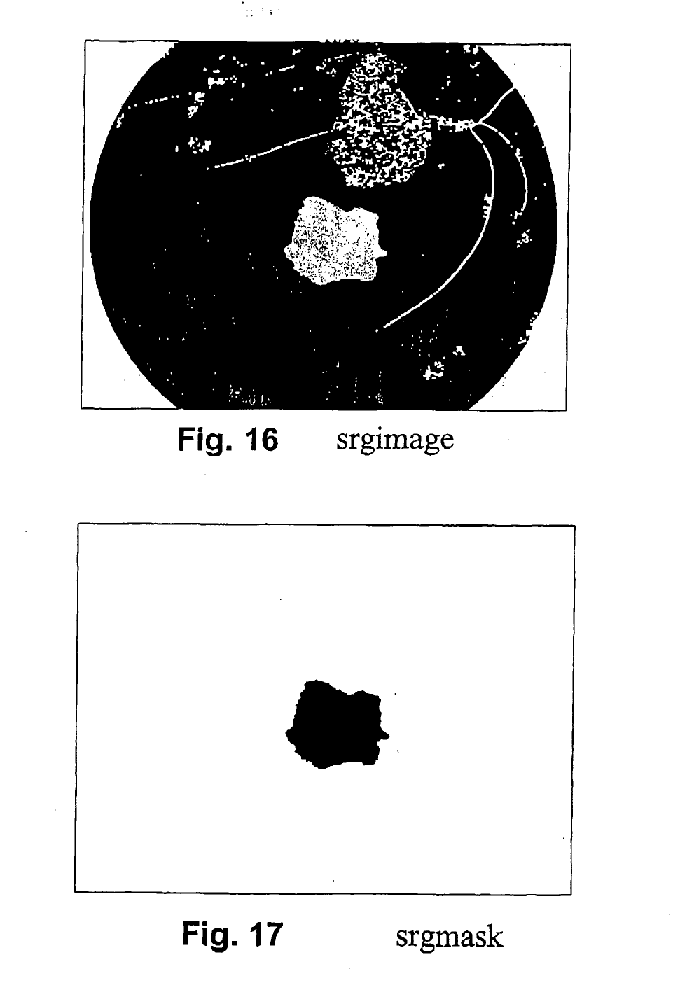

Step 654 then implements a traditional technique of growing the seed pixels of FIG. 15 in the image of FIG. S. The result of such growing are a number of regions of like coloured pixels shown as an SRG image 656 shown in FIG. 16. As will be apparent from a comparison of FIGS. 14, 15 and 16, the seed pixels of FIG. 15, representing lesion and skin, have each been grown throughout the image. Not apparent from FIG. 15, is that the unwanted regions of the image (including hair, bubbles, corners and other out-of-range regions) represent a further class of seeds, which is also allowed to grow. In this example however, that class is not seen to grow in any appreciable manner. Notably, the region growing step 654 acts to grow each of the skin seeds and the lesion seeds to provide the image of FIG. 16 which provides, at the centre at the image, a clear representation of pixels that are construed to be “lesion” surrounded by pixels that are construed to be “skin”. FIG. 16 can therefore be flirter processed to provide a mask image, SRG mask 658, shown in FIG. 17 which represents the specific boundary of the image as a result of seeded region growing that is construed to be “lesion”.

It should be emphasised that the above-noted techniques do not seek to classify that portion defined by the boundary of FIG. 17 as being either lesion or skin, but merely to identify those respective regions for further processing and in particular, the “lesion” region for further investigation and an ultimate determination as to whether or not the identified “lesion” region comprises melanoma or other cancerous tissue.

The processing steps of FIGS. 6A and 6B may be altered in the fashion shown in FIG. 19 which involves the elimination of the creation of the PC1_no_hair and PC2_no_lair images 634 and 638 and the consequential preparation at step 630 and 632.

As seen in FIG. 19, step 642 of FIG. 6B is modified whereby the bivariate mask is applied in a step 662 directly to each of the PC1 and PC2 images 622 and 624 respectively. This provides modified version of the xSEG image 644 (mod_xSEG 664) which incorporates hair and other unwanted components. At a following step 666, each of the bubble mask 610 and the hair mask 614 are subtracted from the mod_xSEG image 666, the output of which is added to unwanted components 668 representing the out-of-range regions of the image of FIG. 14. The result of this process is the same seeds image 648 of FIG. 15 as that previously described. Those seeds may be processed in a like fashion using the previously described steps.

In this way, in order to identify the seeds for seeded region growing, it is not essential that the PC1 and PC2 images be directly processed by applying the hair masks and such may be utilised in their original fashion. It will be further appreciated that other modifications of these approaches can be performed in order to mask out those portions of the images that are specifically undesired for a valuation.

Returning to FIG. 5, the colour cluster multiple border detection process 520 represents an alternative approach to the seeded region growing in order to obtain the detected border 518. However, as will be apparent from the following description, the process 520 relies upon and utilises many of the processing steps and component processed images that were derived and used in seeded region growing, as well as further process component images. In this fashion, the colour cluster multiple border process 520 may be implemented at least in part substantially simultaneously with seeded region growing.

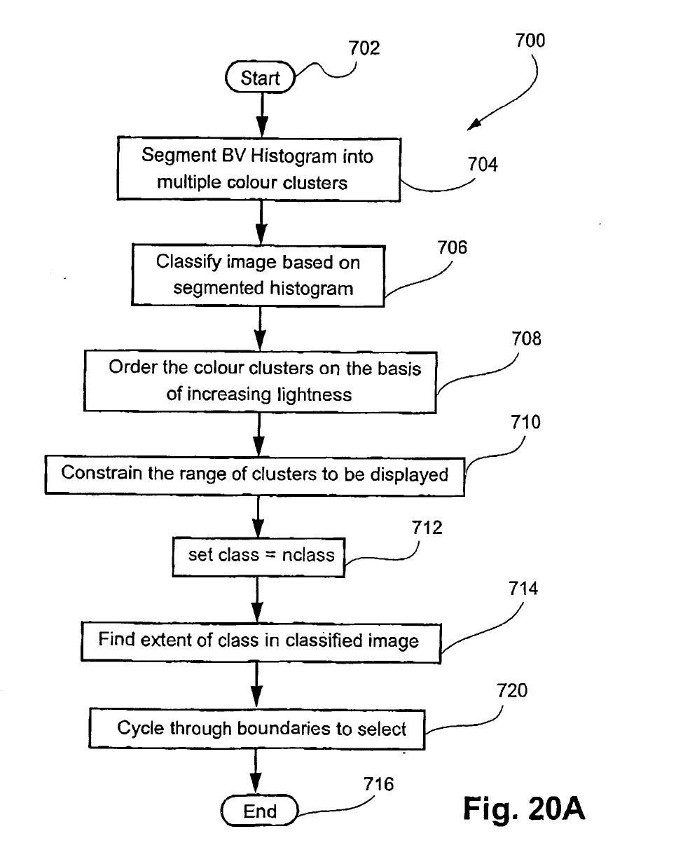

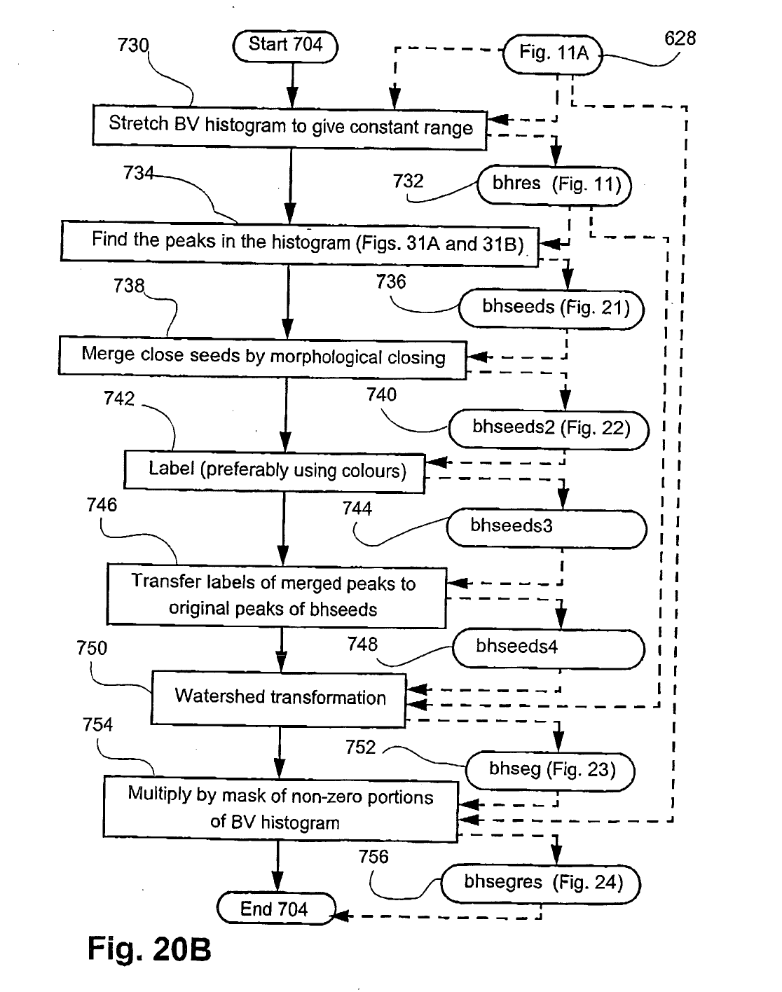

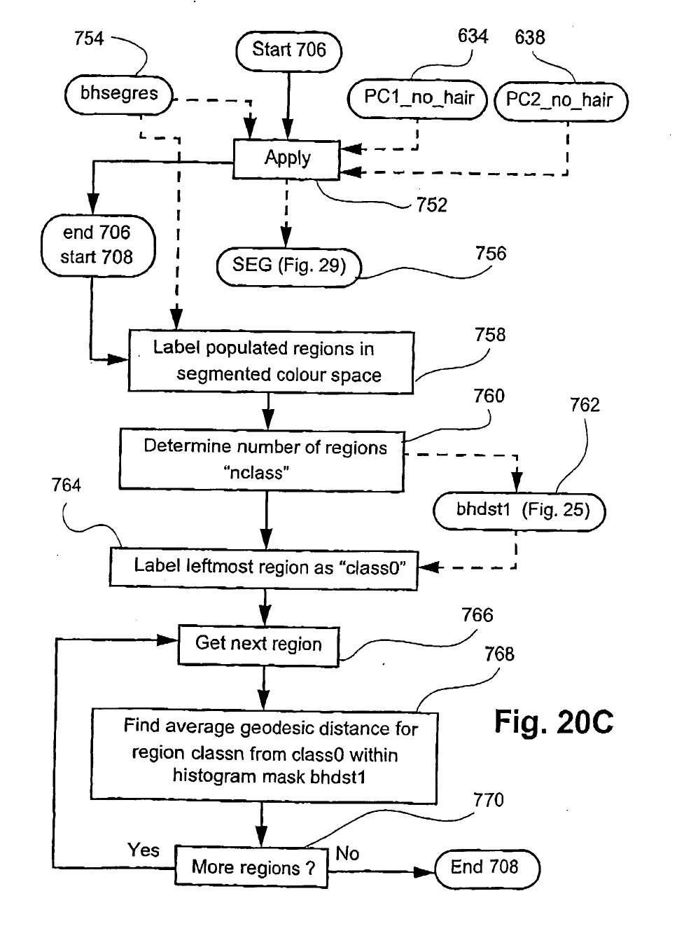

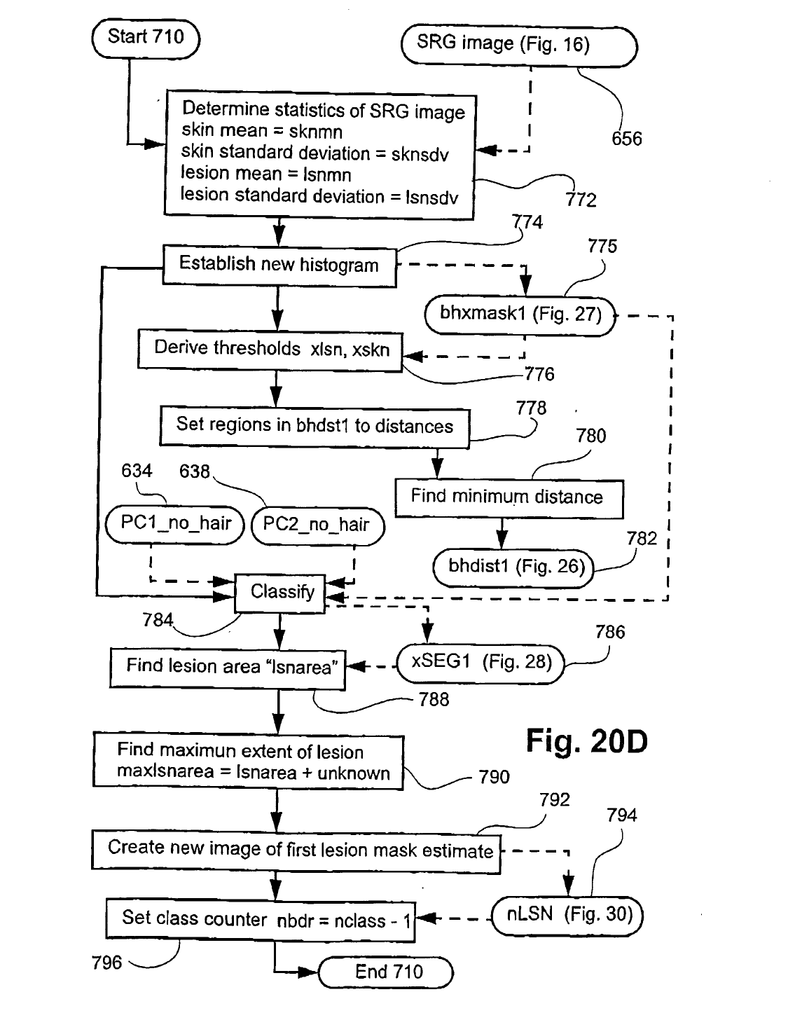

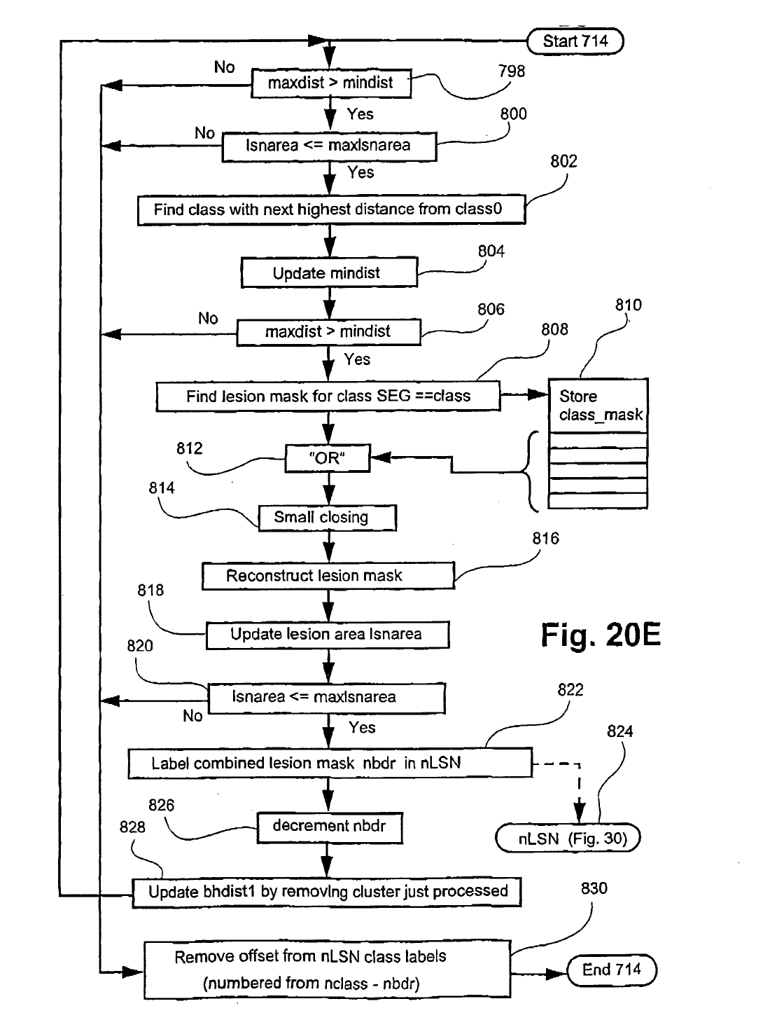

FIG. 20A provides a general flow chart for the colour clustering method 700 with FIGS. 20B to 20E representing the various stages within the flow chart of FIG. 20A. The method 700 operates to determine multiple region boundaries of a skin lesion and commences at step 702 which may be considered indicative of the forerunner processing steps as referred to in the preceding paragraph. In a first substantive step 704, a segmentation of the bivariate histogram 628 is performed to divide the histogram into N multiple colour clusters. This step has the effect of separating the histogram into various regions or clusters indicative of different skin colour types so that each may be processed either separately or together, Step 704 is followed by step 706 where the image is classified based upon the segmented histogram. E this fashion, the segmentation obtained at step 704 is applied to the specific lesion image to provide a general categorisation of the pixel components of the same.

At step 708, the colour clusters are ordered on the basis of increasing lightness into respective classes. This is performed because cancerous tissue typically tends to be darker than non-cancerous tissue. At step 710, the range of colour clusters is preferably constrained. In this regard, typically the number of colour clusters can be quite large for images having a great range of intensity. Since the purpose of the multiple colour cluster method 700 is to provide the physician with a range of boundaries from which the physician may make an appropriate selection, it is desirable to limit the range of boundaries offered to the physician to within an acceptable, reasonable number. Clearly, too few images may not provide the physician with sufficient accuracy to define the lesion boundary whereas too many images may take too long for the physician to interpret to arrive at the desired boundary.

In step 712, a recursive process is anticipated when the class is set to nclass, where nclass is the total number of clusters thereby enabling the various colour clusters to be processed in order by step 714. Step 714 acts to identify the extent of each particular class in order to classify the image. In this fashion, as step 714 progresses through the various classes, as seen in FIG. 32, the region boundaries of each class are added to those of the preceding class to therefore define a progressively growing boundary from the darkest to lightest tissue types, being lesion to skin. Once step 714 has calculated the various boundaries, such may then be made available to the physician who, according to step 720, may cycle through a visual review of the boundaries to make a selection. In this fashion, the physician may presented with initially a small lesion boundary representing those darkest portions of the lesion which are generally indicative of cancerous growth As the various classes are added to the preceding classes, the boundary grows across the lesion to a stage where it commences to encroach upon tissue that may be readily classified as “skin.”. During the “growth” of those region boundaries, the physician may make an appropriate selection The method 700 ends at step 716.

The segmentation of the bivariate histogram in step 704 is illustrated in the flow chart of FIG. 20B. Initially, the bivariate histogram 628 of FIG. 11A is retrieved or, where such has not been determined, is calculated using the methods previously described. At step 730, the bivariate histogram 628 is stretched to give a constant range between the range of values of 0 and 255. This modified histogram bhres 732 is seen in FIG. 11.

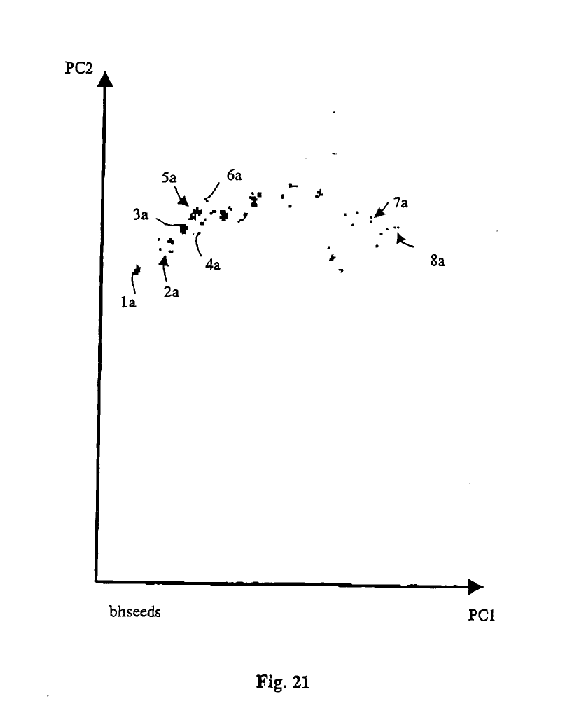

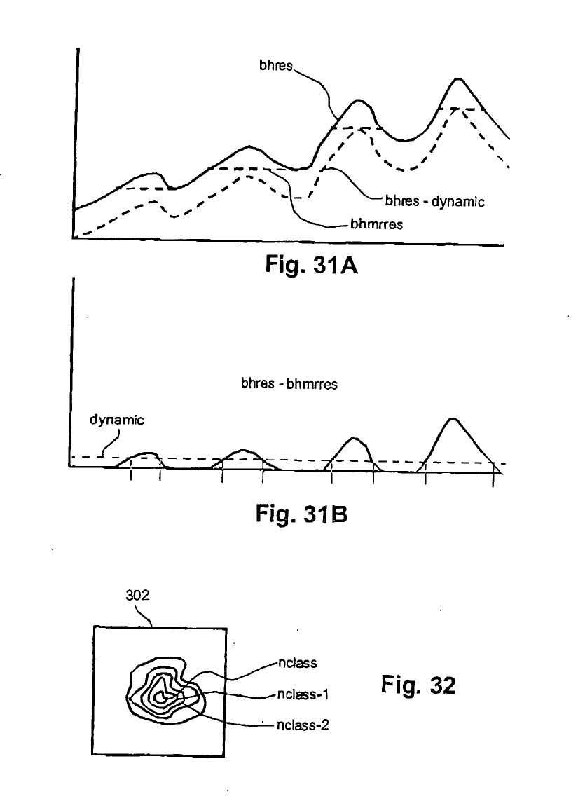

At step 734, which follows, the peaks of the modified bivariate histogram of FIG. 11 are determined by a shearing process. Specifically, step 734 is performed as seen in FIG. 31A by a morphological reconstruction by dilation of a further histogram, bhres-“dynamic”, under the histogram bhres, thereby effectively taking the marker or reference image bhres-“dynamic” and iteratively performing geodesic dilations on this image underneath the mask image, bhres, until idempotence is achieved. The difference between the histogram and histogram shorn of its peaks, (bhres-bhmrres) can then be thresholded to find those peaks greater than the dynamic threshold. Those peaks can be identified as peak seeds as given in FIG. 21 for the image bhseeds. Such a shearing process is illustrated in FIGS. 31A and 31B for a simple one-dimensional case, noting that the bivariate histogram of FIG. 11 is clearly two-dimensional. In FIG. 31A, the peaks are effectively plotted and the plot is then shifted by a predetermined threshold. The shifted plot is then subtracted (or added depending on the direction of shift) from the original to provide a plot shown in FIG. 31B which represents those peaks of the original plot having a magnitude in excess of the predetermined threshold, “dynamic”. The axial coordinates of the peaks as indicated in FIG. 31B are then used to define the location of the peaks in the bivariate histogram. The result of this operation for the example image presently being discussed is an image bhseeds 736 shown in FIG. 21.

A visual comparison of FIGS. 21 and 11 indicates that the portions identified in FIG. 21 represent the local peaks in the various regions of the arrangement of FIGS. 11A and 11B.

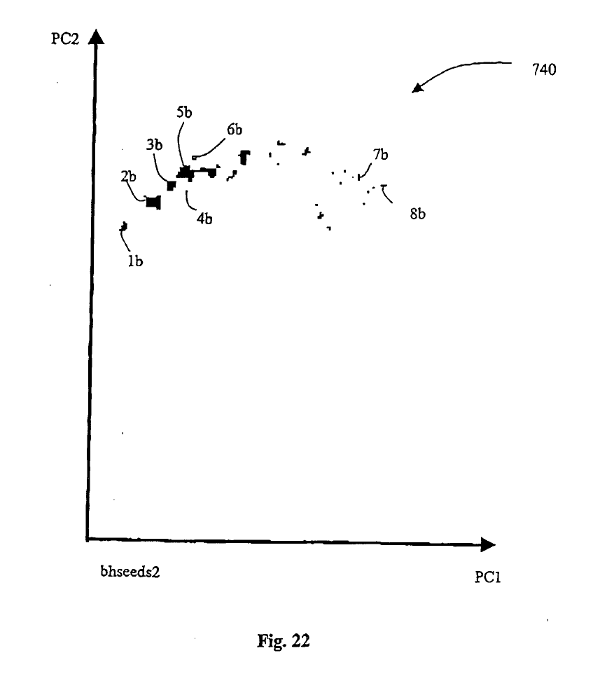

Step 738 then performs a morphological closing upon the seeds of FIG. 21, such effectively grouping together those seeds that are proximate to each other within a particular closing dimension. This results in an image bhseeds 2 740 shown in FIG. 22. En step 742, the seeds of FIG. 22 are then labelled. In a preferred implementation, colour is used to label each of the seeds. Such colour is not apparent in the accompanying black and white Figures. For the purpose of explanation, examples of the merged seeds in FIG. 22 are labelled 1b, 2b, 3b, 4b, 5b, 6b, 7b and 8b, The labels of FIG. 22, being the closed merge seeds can then be applied to the original seeds of FIG. 21, this being performed in step 746. In a preferred implementation, colour is used to label the original seeds. For the purpose of the current description, examples of the original seeds are labelled 1a-8a in FIG. 21. Original seed 1a corresponds to merged seed 1b, seed 2a corresponds to merged seed 2b and similarly original seeds 3a-8a correspond to merged seed 3b-8b respectively.

The seeds of FIGS. 21 and 22 are indicative of those peaks in the bivariate histogram that may be grouped together or related as a single class.

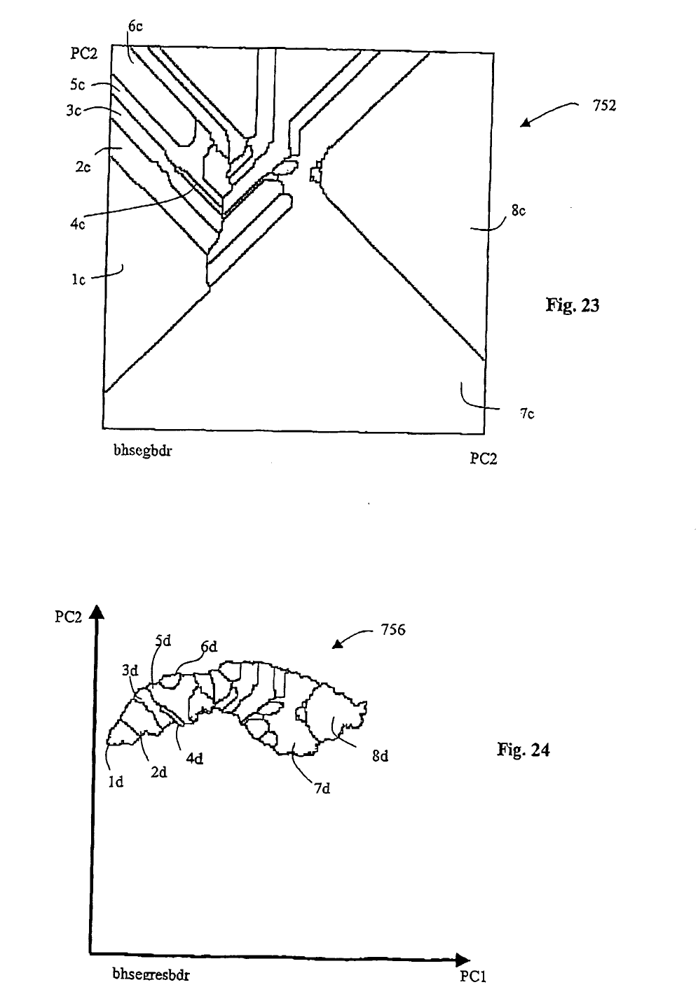

At step 750, a watershed transformation is performed upon the bivarate histogram 628 of FIG. 11A using the seeds obtained from steps 734-746 to thereby divide the entire histogram space into multiple regions as shown in the image bhsegbdr 752 of FIG. 23. As such, a segmentation of the bivarate histogram 732 has been performed based upon the peaks. The morphological watershed transformation effectively searches for the valleys between the various peaks (hence the name watershed), where the valley defines the boundary between the various regions of like intensity. Each of the regions in FIG. 23 corresponds to a cluster of pixels of original colour in the original image space of PC1 and PC2 (or RGB). Regions 1c-8c correspond to seeds 1a-8a repectively.

At step 754, the image of FIG. 23 is multiplied by a mask of non-zero portions of the bivariate histogram 628 to identify the populated portion of the segmented colour space, bhsegresbdr 756, shown in FIG. 24. Populated regions 1d-8d in FIG. 24 correspond to regions 1c-8c in the segmented space of FIG. 23. Step 704 then ends.

Accordingly, from a visual comparison of the bivariate histogram 732 of FIG. 11A or 11B with the segmentation thereof in FIG. 24, it will be appreciated that the bivariate histogram has been segmented into multiple colour clusters, each colour cluster being related to image portions of similar intensity.

Steps 706 and 708 of FIG. 20A are described in detail in FIG. 20C. Initially, the images are classified based upon the segmented histogram of FIG. 24. This is performed in step 752 by applying the segmented bivariate histogram 756 of FIG. 24 to each of the PC1_no_hair and PC2_no_hair images 634 and 638. This results in a segmentation image SEGgry 756, shown in FIG. 29. In a preferred implementation, colour is again used to identify, within the original image, the various locations of die different segmentations of FIG. 24. FIG. 40 is a grey-scale representation of a colour image, and it is possible that because of poor reproduction of the image the distinction between segmented regions may not be readily apparent. In FIG. 29 a clearly identifiable “lesion” class is seen in the centre corresponding to the colour of seed 1a, the identified skin region corresponding to the colour of seed 8a is seen in the lower left portion of the image, and the surrounding substantial regions of unknown tissue type (substantially corresponds to the colour of seed 7a).

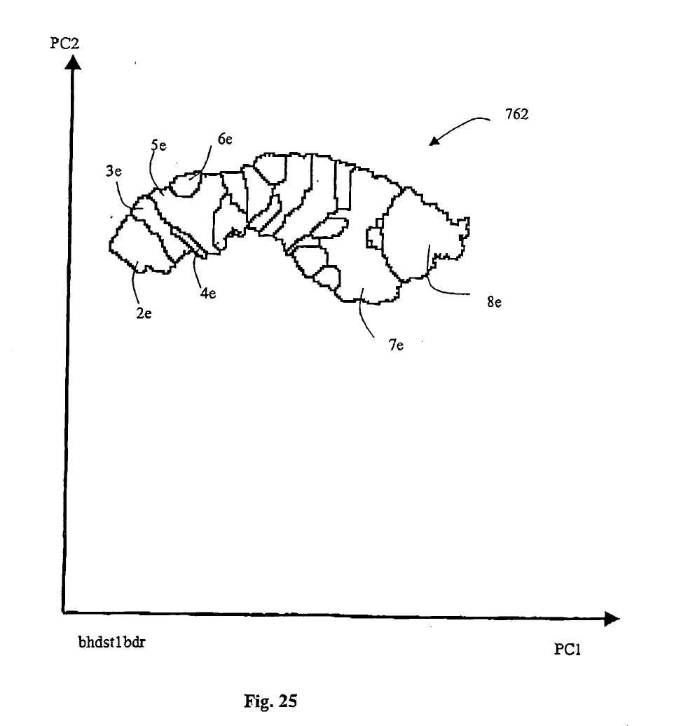

Step 708 orders the various colour clusters on the basis of increasing lightness and, like step 706, also commences with the segmented bivariate histogram 754 of FIG. 24. Step 758 initially labels the populated regions in the segmented colour space. Step 760 which follows determines the actual number of regions “nclass”. In the present case, it will be seen from FIG. 25 that there are 22 in number of such regions, this being identified in a histogram mask image bhdstlbdr 762.

At step 764, the leftmost region (ie. that with the darkest coloured pixels) is labelled as “class0”. Moving from left to right in FIG. 25, step 766 identifies the next region and then step 768 determines the average geodesic distance for that region (classn) from the class0 region within the histogram bhdstlbdr 762 of FIG. 25. At step 770, a test is made whether there are more regions to be processed and, where appropriate, control returns to step 766 which acquires the next region Step 768 again then finds the average geodesic distance. When all regions have been processed, step 708 concludes.

The image 762 of FIG. 25 shows the regions of the histogram ordered with respect to their geodesic distance from class0, the left-most, darkest region, which corresponds to region 1d of FIG. 24. Class0 is not shown in the image 762 as it has a geodesic distance of zero from itself. The first class shown in image 762 is class1 (region 2e), which is closest to class0. Region 8e is the class furthest from class0. In a preferred implementation, colour is used to label the sequence of regions ranging from region 2e to region 8e.

In the present case, there are 22 separate colour clusters and this may be construed as being too many for a physician to review. Where desired, the colour clusters may be constrained in their range according to the process shown in FIG. 20D for the step 710. This arrangement commences with step 772 which examines the SRGimage 656 of FIG. 16, to determine various statistics of the PC1 image. In particular, a mean skin value (sknmn), a skin standard deviation (sknsdv), a lesion mean (lsnmn) and lesion standard deviation (lsnsdv) are determined for the PC1 image using the masks of lesion and skin provided by the SRG image 656 of FIG. 16.

Step 774, which follows, establishes a new histogram mask bhxmaskl 775 shown in FIG. 27, with the range between the leftmost and rightmost extents being divided into three segments as “lesion”, “unknown” and “skin”, this being akin, although not corresponding to the masks of FIG. 12. At step 776, a first threshold (xlsn) between the lesion and unknown regions, and a second threshold (xskn) between the unknown and skin regions, are determined. Such may be determined by initially assigning xlsn=lsnmn and xskn=sknmn. Those thresholds can then be moved towards each other in steps of a single standard deviation until such time as they are separated by three standard deviations. Such may be represented by the following algorithm:

while (xlsn+3*lsnsdv<xskn−3*sknmsdv) {

xlsn=xlsn+lsnsdv

xskn=xskn−sknsdv

}

At step 778, which follows, all regions in the ordered distance histogram bhdstlbdr 762, to the left of xlsn, are set to zero. All the regions to the right of xskn are then set to the maximum distance in that sector (ie. a value “maxdist”). This is followed by step 780 where the minimum distance (“mindist”) is found, the result of which is shown in FIG. 26 as a representation bhdistlbdr 782. As will be apparent from an overlay of FIG. 26 across the mask of FIG. 27, the unknown/skin boundary 12 of the mask of FIG. 27 clearly divides one of the regions in FIG. 26 into two separate regions 7f, 7g, The boundary 12 represents a new x-axis distance.

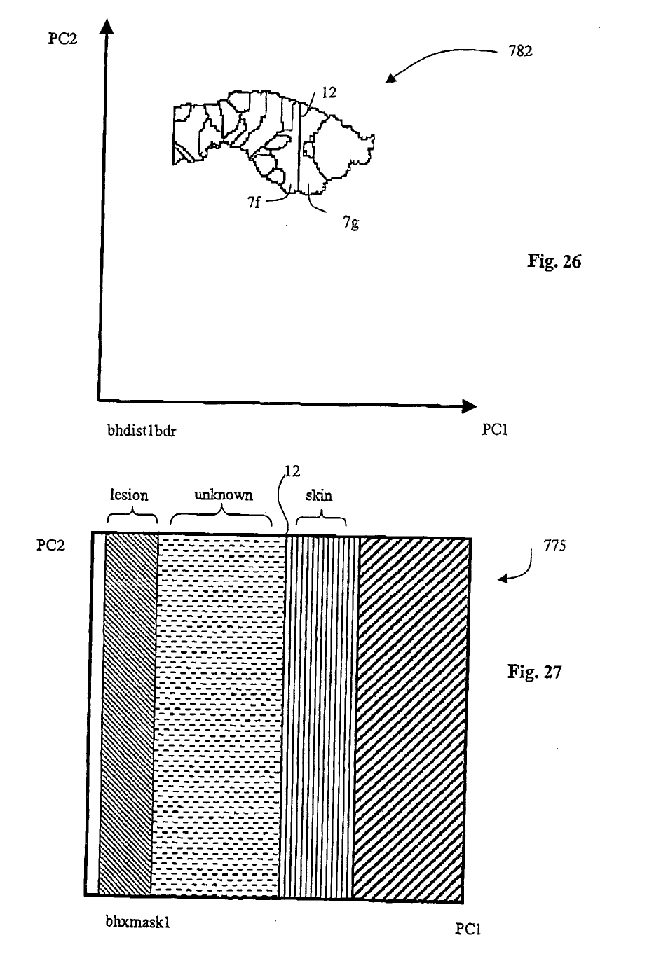

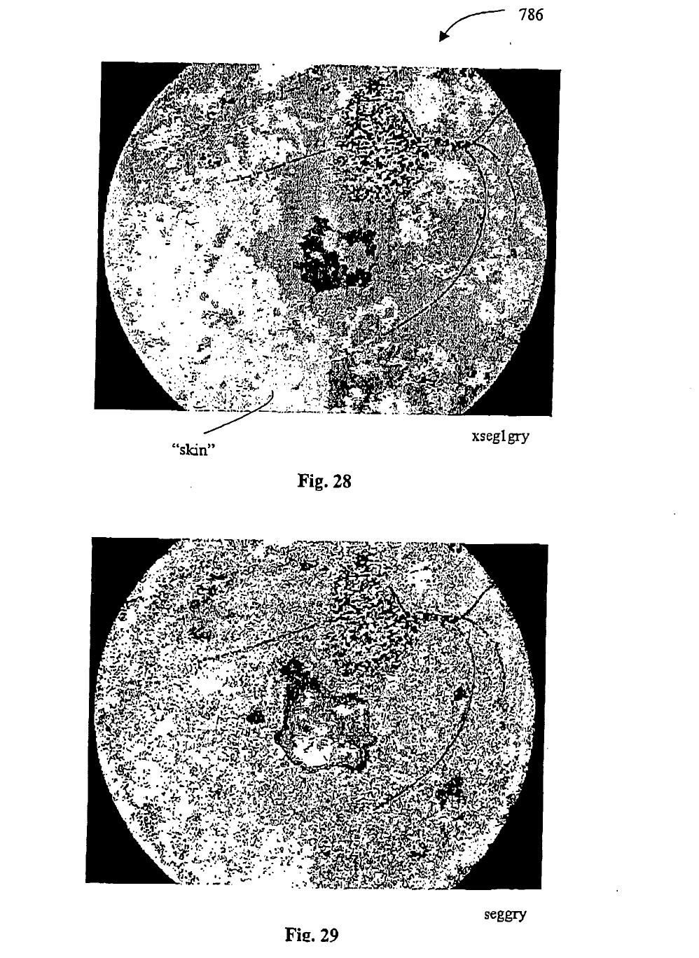

Returning to FIG. 20D, the histogram mask 775 of FIG. 27 is then used at step 784 to classify PC1_no_hair and PC2_no_hair images 634 and 638 into lesion, unknown and skin classes as shown in the image xseg1gry 786 of FIG. 28. Such is effectively equivalent to, although not identical to, the image shown in FIG. 14. Notably, in FIG. 28, much more tissue has been identified as “skin” compared to that of FIG. 14.

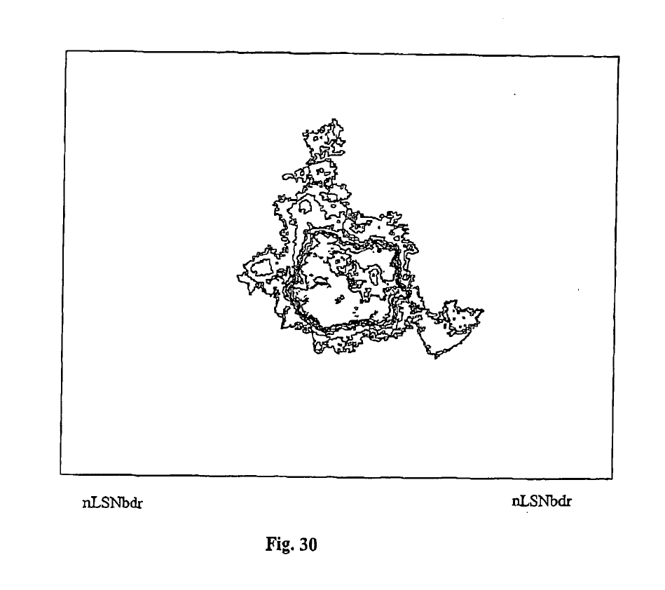

Step 788 then determines the area of the current lesion class in xseg1gry, “lsnarea”. Step 790 then finds the maximum extent of the lesion being a value (maxlsnarea) and representing the area of the lesion plus unknown regions of the image xseg1gry. A new image (nlsnbdr) is then created at step 792 as a first lesion mask estimate. The mask estimate of FIG. 30 is labelled as the value of the total number of clusters, nclass. A class counter is then set in step 796 such that nbdr=nclass−1. The constraining of the image then concludes at step 710. FIG. 41 represents the final result of nlsnbdr after all iterations. In the preferred implementation nLSN is displayed in colour, with different lesion mask estimates indicated in different colours. The black and white representation of nLSN shown in FIG. 30, nLSNbdr merely shows estimated boundaries. In the absence of colour the association of different boundaries with corresponding regions of the histogram 782 is not readily apparent.

Turning now to FIG. 20E, step 714 is shown as a further flow chart. Essentially, step 714 provides a calculation of areas of the image that are representative of a combination of the clustered region from the first lesion mask estimate. Step 714 commences with step 798 which checks that a value of maximum distance remains greater than minimum distance in the mask of FIG. 27. If such is maintained, step 800 follows where a check is determined that the lesion area is less than or equal to the maximum lesion area previously calculated. Such then commences a recursive loop which, at step 802, initially finds the class with the next highest distance from class0, class0 being used to identify the first lesion mask estimate at steps 710. When this is performed, step 804 updates the minimum distance. Step 806 then again checks that the maximum distance remains greater than minimum distance. If such is the case, a lesion mask is then determined for the particular class being processed based upon the segmentation image of FIG. 29. This mask is stored at step 810 and at step 812, the mask just stored is then combined, using a logical OR operation 812 with all previously determined and stored lesion masks. A small closing is then performed at step 814 on the boundary defined by the “OR” operation 812 to ensure that narrow troughs or indentations are avoided. At step 816, a reconstruction of the lesion mask with the previous boundary mask is performed and this reconstruction represents the new updated boundary mask that may be displayed to the physician. At step 818, the lesion area is then updated and a check at step 820 is again performed to ensure that the lesion area remains less than or equal to the maximum lesion area. If so, the combined lesion mask is labelled as the value nbdr in nlsnbdr. Label boundaries can be seen from the various colours represented in FIG. 30. At step 826, nbdr is decremented and at step 828, the location in bhdistlbdr is then updated by removing the colour cluster just processed. Control then returns from step 828 to step 798 for processing of the next colour cluster. Where the results of step 798, 800, 806 and 820 are in the negative, the process is terminated and step 830 follows by removing the offset from the class labels of nlsnbdr so that they are numbered consecutively from 1 to the value of nclass−nbdr (rather than from nbdr to nclass). The physician is then in a position to recall any class number and then be provided with a display of the appropriate boundary corresponding to that class, Step 714 then terminates as does the process 700.

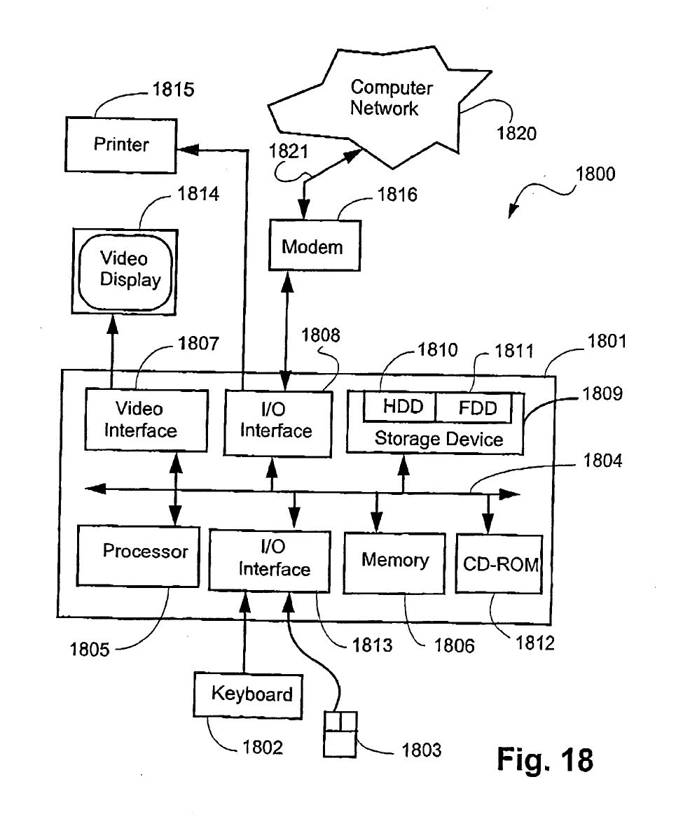

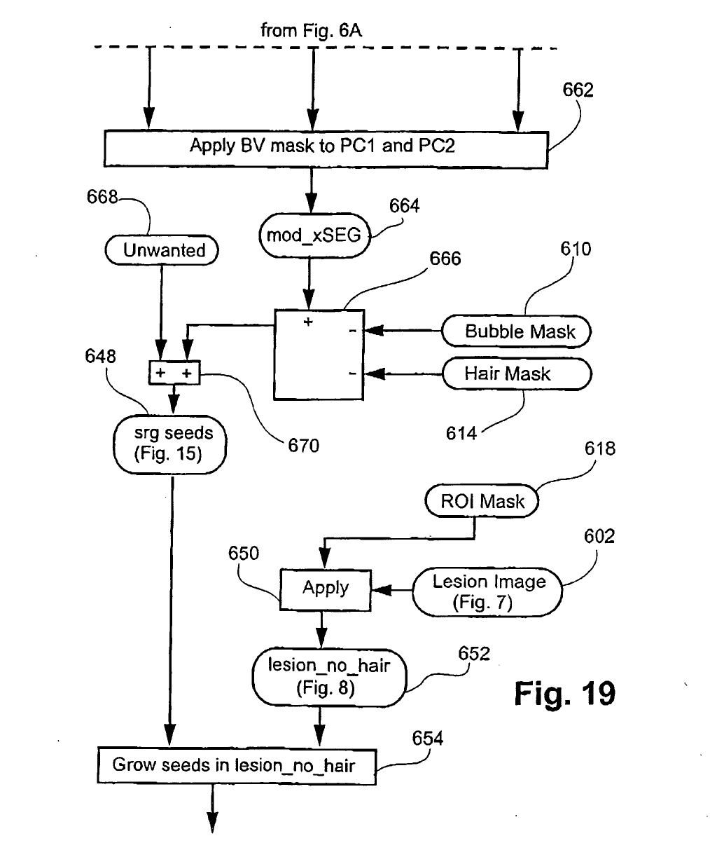

In practice, returning to FIG. 18, the computer arrangement and user interface of the computer system 1800 may be supplemented by a slider-type control which has an effective range of, say, 1 to 20, whereby the physician may move the slider control from 1 to 20 and in doing so, step through the various boundaries defined by the various colour clusters depicted in FIG. 30, or as schematically illustrated in FIG. 32 with respect to the image 302 of FIG. 3. As a consequence, the physician is in a position to grow the various boundaries, both from within and from without the lesion as illustrated. The arrangement of FIG. 30 may be overlaid across the original lesion image of FIG. 7 or 20, thereby providing the physician with the ability to accurately identify to his or her level of experience, the desired boundary chosen for later processing.

Should either of the seeded region growing or colour clustering techniques be unsuccessful in providing to the physician an appropriate border for the lesion, the physician may then utilise traditional tracing techniques to manually create an electronic border which may be applied to the image. To perform this, the image containing the lesion is displayed on the display 414 and the physician utilises the mouse 118 to trace a line about what the physician considers to be the area of interest. The traced line is in effect a locus of straight lines between individual points which may be identified by the physician clicking the mouse 118 at desired locations about the lesion.

Trials conducted by the present inventors using a sample of 1,000 images of different lesions indicate that, having applied a broad dermatological experience to an assessment of the boundaries detected, that the seeded region growing and colour cluster multiple border techniques are successful in approximately 85% of cases, with the physician choosing to manually trace the border in the remaining 15% of cases. However, it is noted that such a trial was based upon a highly skilled dermatological examination of the original image and, in practice, where the system 100 may be utilised by persons without specific dermatological experience, it may be found that the seeded region growing and colour clustering techniques can provide either a fully automated or an assisted determination of the border of a lesion without substantial manual intervention.

The methods described here may be practiced using a general-purpose computer system 1800, such as that shown in FIG. 18 wherein the processes of FIGS. 5 to 31B may be implemented as software, such as an application program executing within the computer system 1800. In this fashion the system 1800 represents a detailed depiction of the components 110-118 of FIG. 1. In particular, the steps of the methods are effected by instructions in the software that are carried out by the computer. The software may be divided into two separate parts in which one part is configured for carrying out the border detection methods, and another part to manage the user interface between the latter and the user. The software may be stored in a computer readable medium, including the storage devices described below, for example, The software is loaded into the computer from the computer readable medium, and then executed by the computer. A computer readable medium having such software or computer program recorded on it is a computer program product. The use of the computer program product in the computer preferably effects an advantageous apparatus for dermatological processing.

The computer system 1800 comprises a computer module 1801, input devices such as a keyboard 1802 and mouse 1803, output devices including a printer 1815 and a display device 1814. A Modulator-Demodulator Modem) transceiver device 1816 is used by the computer module 1801 for communicating to and from a communications network 1820, for example connectable via a telephone line 1821 or other functional medium. The modem 1816 can be used to obtain access to the Internet, and other network systems, such as a Local Area Network (LAN) or a Wide Area Network (WAN).

The computer module 1801 typically includes at least one processor unit 1805, a memory unit 1806, for example formed from semiconductor random access memory (RAM) and read only memory (ROM), input/output (I/O) interfaces including a video interface 1807, and an 110 interface 1813 for the keyboard 1802 and mouse 1803 and optionally a joystick (not illustrated), and an interface 1808 for the modem 1816. A storage device 1809 is provided and typically includes a hard disk drive 1810 and a floppy disk drive 1811. A magnetic tape drive (not illustrated) may also be used A CD-ROM drive 1812 is typically provided as a non-volatile source of data The components 1805 to 1813 of the computer module 1801, typically communicate via an interconnected bus 1804 and in a manner which results in a conventional mode of operation of the computer system 1800 known to those in the relevant art. Examples of computers on which the described arrangements can be practised include IBM-PC's and compatibles, Sun Sparcstations or alike computer systems.

Typically, the application program is resident on the hard disk drive 1810 and read and controlled in its execution by the processor 1805. Intermediate storage of the program and any data fetched from the network 1820 may be accomplished using the semiconductor memory 1806, possibly in concert with the hard disk drive 1810. In some instances, the application program may be supplied to the user encoded on a CD-ROM or floppy disk and read via the corresponding drive 1812 or 1811, or alternatively may be read by the user from the network 1820 via the modem device 1816. Still fiber, the software can also be loaded into the computer system 1800 from other computer readable media. The term “computer readable medium” as used herein refers to any storage or transmission medium that participates in providing instructions and/or data to the computer system 1800 for execution and/or processing, Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1801. Examples of transmission media include radio or infra-red transmission channels as well as a network connection to another computer or networked device, and the Internet or Intranets including email transmissions and information recorded on websites and the like.

The processing methods may alternatively be implemented in dedicated hardware such as one or more integrated circuits performing the described functions or sub functions. Such dedicated hardware may include graphic processors, digital signal processors, or one or more microprocessors and associated memories.

### INDUSTRIAL APPLICABILITY

It is apparent from the above that the arrangements described are applicable to the assisted diagnosis of dermatological anomalies.

The foregoing describes only some embodiments of the present invention, and modifications and/or changes can be made thereto without departing from the scope and spirit of the invention, the embodiments being illustrative and not restrictive.

Australia Only

In the context of this specification, the word “comprising” means “including principally but not necessarily solely” or “having” or “including” and not “consisting only of”. Variations of the word comprising, such as “comprise” and “comprises” have corresponding meanings.

1. A method of determining a boundary of a lesion on the skin of a living being, said method comprising the steps of:
obtaining an image of the lesion and a surrounding skin area;
performing a test upon pixels in said image representing a predetermined portion of said surrounding skin area;
and, in response to said test, performing at least one of:
(a) a seeding region growing method to determine a boundary of said lesion; and
(b) a colour cluster method to determine a plurality of selectable boundaries of said image.

2. A method according to claim 1, wherein said test comprises determining a variance in colour for pixels located about a circle surrounding said lesion such that where said variance falls below a predefined value, said seeded region growing method is performed, and where said variance exceeds said predefined value, said colour cluster method is performed.

3. A method according to claim 1 or 2, further comprising the steps of:
presenting the boundary determined in step (a) to a user for examination;
receiving an input from said user that indicates whether said boundary is deemed appropriate; and
where said input indicates that said boundary is deemed inappropriate, said method further comprises performing step (b).

4. A method according to claim 1 or 2, further comprising the steps of:
presenting the boundaries determined in step (b) to the user for examination;
receiving an input from said user that indicates whether said boundaries are deemed appropriate; and
where said input indicates that none of said boundaries are deemed appropriate, said method further comprises receiving a boundary of said lesion electronically traced by said user.

5. A method according to claim 3 on wherein the step of presenting the boundary comprises displaying the boundary for a visual examination by the user.

6. A method for forming a transformation matrix for application to images for dermatological examination, said method comprising the steps of:
obtaining sample data representing a plurality of skin images each including at least one lesion and surrounding skin;
arranging said data in a single three-dimensional colour space as a single set of pixels;
determining, from said set of pixels, principal component axes thereof; and
using the principal component axes to determine a corresponding transformation matrix thereof.

7. A method of determining seed pixels as a precursor to seeded region growing to identify the boundary of a skin lesion in dermatological examination, said method comprising the steps of:
(a) obtaining a source image of the lesion and a surrounding area of skin;
(b) performing a dimension reduction transformation upon colour components of said image to form first and second transformed images;
(c) computing a bivariate histogram using said transformed images;
(d) forming from said histogram a (first) mask to identify, in the transformation space, relative locations of lesion pixels, skin pixels and unknown pixels;
(e) applying the first mask to at least one of the transformed images to form an initial segmentation; and
(f) applying at least one further mask to said initial segmentation to remove unwanted portions of said image to reveal seed pixels for each of lesion and skin.

8. A method according to claim 7 wherein said dimension reduction transformation is performed using a transformation matrix formed according to the method of claim 6.

9. A method according to claim 7 or B, wherein said first mask comprises variations only in an axis of one said transformed image that is substantially intensity sensitive.

10. A method according to claim 9, wherein said bivariate histogram comprises values contributed by said one transformed image.

11. A method according to any one of claims 7, 9 or 10, wherein said at least one further mask is formed by preprocessing said source image to remove unwanted image components thereof.

12. A method according to claim 11, wherein said unwanted image components comprise hair, bubbles and colour calibration segments, said preprocessing forming, for each said component, a corresponding mask.

13. A method according to claim 12, further comprising combining each of said corresponding masks to form a region of interest mask for said source image.

14. A method according to claim 13, further comprising applying said hair component mask to each said transformed image to form corresponding transformed-no-hair images, and step (e) comprises applying said first mask to said transformed-no-hair images.

15. A method according to claim 14, wherein step (f) comprises subtracting said region of interest mask from said initial segmentation.

16. A method according to claim 12, wherein step (f) comprises subtracting from said initial segmentation each of said corresponding masks.

17. A method of determining a boundary of a lesion on the skin of a living being, said method comprising the steps of:
(i) determining at least lesion and skin seed pixels according to the method of any one of claims 7, 9 or 10;
(ii) removing from said source image unwanted regions thereof to form a working image;
(iii) growing at least said lesion seed pixels and said skin seed pixels by applying a region growing process to said seed pixels in said working image; and
(iv) masking out said skin pixels from said grown image to form a mask defining the boundary of said grown lesion pixels.

18. A method of determining a boundary of a lesion on the skin of a living being, said method comprising the steps of:
(a) obtaining a source image of the lesion including a surrounding area of skin;
(b) forming a bivariate histogram from dimension reduction transformations of said source image;
(c) segmenting said source image using a segmentation of said histogram and classifying the segments;
(d) ordering the segments on the basis of increasing lightness;
(e) applying the classified segments in order to said image to form, for each application, a corresponding boundary related to said lesion; and
(f) selecting from said boundaries a representative boundary of said lesion.

19. A method according to claim 18 wherein said dimension reduction transformation is performed using a transformation matrix formed according to the method of claim 6.

20. A method according to claim 18 or 19, wherein step (e) comprises forming a first boundary related to a darkest one of said segments and forming remaining boundaries enclosing each previously formed boundary for the corresponding said segment.

21. A method according to claim 18, or 19, wherein step (b) comprises the substeps of:
(ba) forming a region of interest mask from said source image to remove unwanted image components;
(bb) performing dimension reduction transformations of said source image to form corresponding transformed images; and
(bc) computing said bivariate histogram from said transformed images over an area defined by said region of interest mask.

22. A method according to any one of claims 18 or 19, wherein the segmenting of step (c) comprises the substeps of:
(ca) determining peaks in said histogram;
(cb) performing a morphological closing upon said peaks to form merged seeds;
(cc) labelling the merged seeds and transferring each label to a corresponding said peak in said histogram;
(cd) determining boundaries between adjacent, differently labelled ones of said peaks; and
(ce) masking non-contributing portions of said histogram by applying said boundaries to said histogram to define said segments each related to at least one of said peaks.

23. A method according to claim 18, wherein said classifying comprises the substeps of:
(cf) masking unwanted components from at least one of said transformed images; and
(cg) applying the segmentation of said histogram to said at least one transformed image to form a segmentation of said source image.

24. A method according to claim 23, wherein step (d) comprises the substeps of:
(da) labelling regions in said segmentation of said histogram and determining a number thereof;
(db) assigning a darkest one of said regions as an initial class; and
(dc) for each remaining region, determining a distance thereof to the darkest region to form, for each subsequent class corresponding to a remaining region, a distance-based segmentation.

25. A method according to claim 24, wherein said distance-based segmentation acts to like-classify segments of said histogram related to different lightness but having a like determined distance.

26. A method according to claim 24 or 25, wherein said distance is an average geodesic distance from the darkest said region to the corresponding remaining region.

27. A method according to any one of claims 18 or 19, further comprising, between steps (d) and (e), the step of:
(f) constraining the number of segments to within a predetermined value.

28. A method according to claim 27, wherein step (f) comprises the sub-steps of:
(fa) determining statistics of a seeded region grown image formed according to claim 17 for each of skin and lesion;
(fb) using said statistics to form a modified histogram mask from which threshold distances for each of lesion and skin can be determined,
(fc) using the threshold distances and the segmentation to determine a first lesion boundary estimate; and
(fd) obtaining from said first lesion boundary estimate the lesion area.

29. A method according to claim 28, wherein step (fc) further comprises determining a maximum extent of lesion by summing the lesion area value with a further value representing an unknown portion of the image.

30. A method according to claim 29 when dependent on at least claims 18 and 24, wherein step (e) comprises the substeps of:
(ea) finding a class segment with a next highest distance from the initial class:
(eb) determining a current lesion mask for said class segment;
(ec) combining said current lesion mask with each preceding lesion mask;
(ed) reconstructing a boundary mask defining a current boundary of the combined current lesion mask and the preceding masks; and
(ee) repeating steps (ea) to (ed) for each class segment in order.

31. A method according to claim 30, wherein step (ec) further comprises performing a small closing on the combined mask.

32. A method according to claim 30, wherein step (ec) further comprises re-calculating the lesion area based upon the combined mask and steps (ea) and (ec) check that the lesion area remains within the determined maximum extent thereof.

33. A computer program for execution upon a computer device for determining a boundary of a lesion, said program comprising code for:
obtaining an image of the lesion and a surrounding skin area;
performing a test upon pixels in said image representing a predetermined portion of said surrounding skin area;
and, in response to said test, performing at least one of:
(a) a seeding region growing method to determine a boundary of said lesion; and
(b) a colour cluster method to determine a plurality of selectable boundaries of said image.

34. A computer readable medium, having a program recorded thereon, where the program is configured to make a computer execute a procedure for determining a boundary of a lesion on the skin of a living being, comprising the steps of:
obtaining an image of the lesion and a surrounding skin area;
performing a test upon pixels in said image representing a predetermined portion of said surrounding skin area;
and, in response to said test, performing at least one of:
(a) a seeding region growing method to determine a boundary of said lesion; and
(b) a colour cluster method to determine a plurality of selectable boundaries of said image.

35. A dermatological examination system to determine a boundary of a lesion on the skin of a living being, the system comprising:
image capture means for obtaining an image of the lesion and a surrounding skin area;
means for determining a boundary of said lesion using a seeded region growing method;
means for determining a plurality of selectable boundaries of said lesion using a colour clustering method; and
means for performing a selection test on pixels in said image representing a predetermined portion of said surrounding skin area, wherein a result of said selection test determines which of said seeded region growing method and said colour clustering method is applied to said image.

36. A method according to any one of claims 1, wherein said seeded region growing method comprises the method of claim 7, and said colour cluster method comprises the method of claim 18.

37. (cancel).

38. (cancel).

39. (cancel).
